(19) United States
(12) Patent Application Publication
(10) Pub. No.: US 2023/0304804 A1
(43) Pub. Date: Sep. 28, 2023

(54) TRAVEL ROUTE GENERATION DEVICE, VEHICLE CONTROLLER, AND COMPUTER-READABLE MEDIUM STORING TRAVEL ROUTE GENERATION PROGRAM

(71) Applicants: ADVICS CO., LTD., Kariya-shi (JP); J-QuAD DYNAMICS INC., Tokyo (JP); DENSO CORPORATION, Kariya-city (JP); AISIN CORPORATION, Kariya-shi (JP); JTEKT CORPORATION, Kariya-shi (JP)

(72) Inventor: Yosuke OHMORI, Tokyo (JP)

(73) Assignees: ADVICS CO., LTD., Kariya-shi (JP); J-QuAD DYNAMICS INC., Tokyo (JP); DENSO CORPORATION, Kariya-city (JP); AISIN CORPORATION, Kariya-shi (JP); JTEKT CORPORATION, Kariya-shi (JP)

(21) Appl. No.: 18/160,092

(22) Filed: Jan. 26, 2023

(30) Foreign Application Priority Data
Jan. 31, 2022 (JP) 2022-013223

(51) Int. Cl. G01C 21/34; B60W 60/00; B60W 40/072

(52) U.S. Cl. CPC G01C 21/3415; B60W 40/072; B60W 60/0016; G01C 21/3461; B60W 2552/30

(57) ABSTRACT

A controller computes availability of the vehicle that indicates a range reachable by the vehicle by actuation of the actuator and generates a first travel route within a range of the availability of the vehicle, as a travel route followed by the vehicle, when the vehicle travels along a road ahead of the vehicle from a present position. When the road includes a curve and the first travel route cannot be generated within the availability range, the controller sets a target position to a position in the road located before the curve and generates a second travel route within the availability range, as the travel route followed by the vehicle, to stop the vehicle at the target position.

### 1. FIELD

The following description relates to a travel route generation device, a vehicle controller, and a computer-readable medium storing a travel route generation program.

### 2. DESCRIPTION OF RELATED ART

German Patent Application Publication No. 102013213171 describes a vehicle controller that executes autonomous driving control on a vehicle. The vehicle controller includes a route generation unit, which generates a standard route using information of a route from the present location to a destination, and a control unit, which controls an actuator related to traveling of the vehicle based on the generated standard route. In addition to the standard route, the route generation unit generates a safety route from the present position of the vehicle to the closest position where the vehicle can be stopped safely.

When the control unit cannot continue to use the standard route to execute autonomous driving control, the control unit switches to the safety route to execute autonomous driving control. This allows the vehicle controller to drive the vehicle along the safety route and stop the vehicle at a safe position.

The vehicle control device continues to generate both a standard route and a safety route while executing the autonomous driving control. This increases the control load on the vehicle controller.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a travel route generation device generates a travel route followed by a vehicle when the vehicle is autonomously driven by actuation of an actuator related to traveling of the vehicle. The travel route generation device includes an availability computation unit configured to compute availability of the vehicle that indicates a range reachable by the vehicle by actuation of the actuator, and a route generation unit configured to generate a first travel route within a range of the availability of the vehicle, as the travel route followed by the vehicle, when the vehicle travels along a road ahead of the vehicle from a present position. When the road includes a curve and the first travel route cannot be generated within the availability range, the route generation unit is configured to set a target position to a position located before the curve and generate a second travel route within the availability range, as the travel route followed by the vehicle, to stop the vehicle at the target position.

When the actuator related to traveling of the vehicle cannot function normally during autonomous driving of the vehicle, the availability range of the vehicle is reduced in size. In this case, the travel route generation device cannot generate the first travel route along the road ahead of the vehicle in the availability range. Thus, when the first travel route cannot be generated, the travel route generation device generates the second travel route within the availability range to stop the vehicle at a target position set to a position located before a curve. Then, the vehicle is autonomously driven along the second travel route and stopped at the target position. In this manner, the travel route generation device keeps the vehicle on the road and avoids a situation in which the vehicle is stopped in the middle of a curve. Further, the travel route generation device generates the second travel route only when the vehicle has to be stopped. Since both of the first travel route and the second travel route are not always generated, the travel route generation device keeps the control load required to generate the travel route as low as possible.

In another general aspect, a vehicle controller is provided. The vehicle controller includes the travel route generation device described above and an instruction unit. The instruction unit is configured to calculate an instruction value for the actuator based on the travel route generated by the route generation device and send the instruction value to a controller for the actuator in order to autonomously drive the vehicle.

In a further general aspect, a computer-readable medium stores a travel route generation program executed by a computer of a vehicle. The travel route generation program is configured to have the computer generate a travel route followed by the vehicle when the vehicle is autonomously driven by actuation of an actuator related to traveling of the vehicle. The travel route generation program has the computer execute an availability computation process that computes availability of the vehicle that indicates a range reachable by the vehicle by actuation of the actuator and a first route generation process that generates a first travel route within a range of the availability of the vehicle, as the travel route followed by the vehicle, when the vehicle travels along a road ahead of the vehicle from a present position. When the road includes a curve and the first travel route cannot be generated within the availability range, the travel route generation program has the computer execute a second route generation process that sets a target position to a position located before the curve and generate a second travel route within the availability range, as the travel route followed by the vehicle, to stop the vehicle at the target position.

Other features and aspects will be apparent from the following detailed description, the drawings, and the claims.

### BRIEF DESCRIPTION OF THE DRAWINGS

FIG. 1 is a schematic diagram showing a vehicle including one embodiment of a vehicle controller.

FIG. 2 is a schematic diagram illustrating an availability range of the vehicle.

FIG. 3 is a flowchart illustrating a process executed by the controller to autonomously drive the vehicle.

FIG. 4 is a schematic diagram illustrating a travel route for autonomous driving of the vehicle.

FIG. 5 is a schematic diagram illustrating a travel route for autonomous driving of the vehicle.

FIG. 6 is a schematic diagram illustrating a travel route for autonomous driving of the vehicle.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art

One embodiment of the present disclosure will now be described.

### Vehicle Configuration

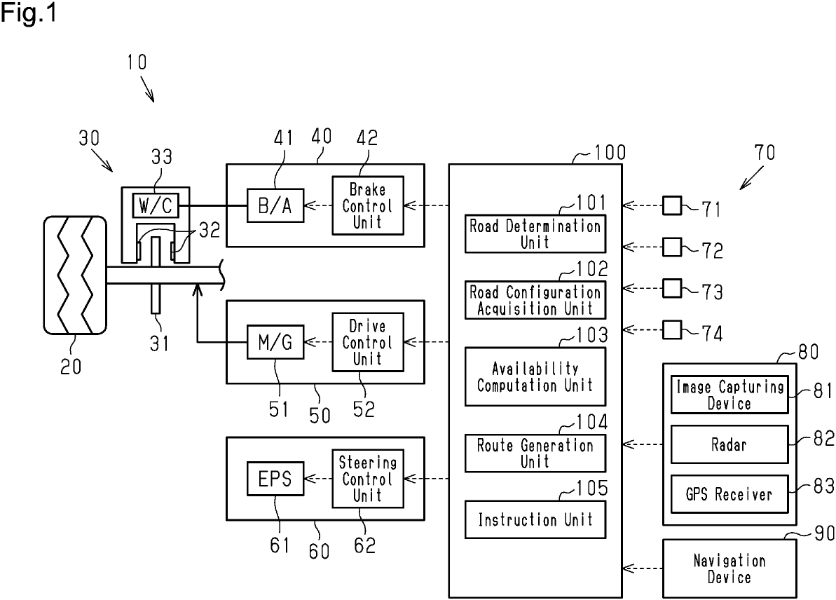

As shown in FIG. 1, a vehicle 10 includes wheels 20, friction brakes 30, the number of which is the same as the wheels 20, a brake device 40, a drive device 50, a steering device 60, a detection system 70, a monitoring system 80, a navigation device 90, and a controller 100.

Each friction brake 30 is a brake mechanism that applies braking force to the corresponding wheel 20. The friction brake 30 includes a disc 31, friction members 32, and a wheel cylinder 33. The wheel cylinder 33 generates liquid pressure, or WC pressure, to force the friction members 32 against the disc 31, which rotates integrally with the wheel 20. This applies braking force to the wheel 20. As the WC pressure increases, the force pressing the friction members 32 against the disc 31 increases thereby increasing the braking force.

The brake device 40 includes a brake actuator 41, which supplies brake fluid to the wheel cylinders 33 of the friction brakes 30, and a brake control unit 42, which controls the brake actuator 41. The brake control unit 42 controls the brake actuator 41 to adjust the WC pressure of the wheel cylinders 33. That is, the brake control unit 42 adjusts the WC pressure of the wheel cylinders 33 to adjust the braking force applied to the vehicle 10. The braking force applied to the vehicle 10 is the total braking force applied to the wheels 20. In this respect, the brake actuator 41 is one example of “the actuator related to traveling of the vehicle 10,” and the brake control unit 42 is one example of “the control unit (or control circuit) for the actuator.”

The drive device 50 includes a motor generator 51, which functions as a power source of the vehicle 10, and a drive control unit 52, which controls the motor generator 51. The driving force of the motor generator 51 is transmitted to the wheels 20 to drive the vehicle 10. In this respect, the motor generator 51 is one example of “the actuator related to traveling of the vehicle 10,” and the drive control unit 52 is one example of “the control unit (or control circuit) for the actuator.”

The steering device 60 includes a steering actuator 61, which adjusts the steering angle of the wheels 20, and a steering control unit 62, which controls the steering actuator 61. The steering actuator 61 generates an output that adjusts the steering angle of the wheels 20 and turns the vehicle 10. In this respect, the steering actuator 61 is one example of “the actuator related to traveling of the vehicle 10,” and the steering control unit 62 is one example of “the control unit (or control circuit) for the actuator.” The steering device 60 includes at least one of a front wheel steering actuator that adjusts the steering angle of the front wheels and a rear wheel steering actuator that adjusts the steering angle of the rear wheels.

In the description hereafter, the adjustment range and adjustment speed of the braking force applied by the brake actuator 41 to the vehicle 10 is referred to as “the capability of the brake actuator 41.” The adjustment range and adjustment speed of the driving force applied by the motor generator 51 to the vehicle 10 is referred to as “the capability of the motor generator 51.” The adjustment range and adjustment speed of the steering angle of the wheels 20 determined by the steering actuator 61 is referred to as “the capability of the steering actuator 61.”

### Detection System

The detection system 70 detects the state of the vehicle 10 that changes as the vehicle 10 travels. The detection system 70 includes sensors that detect the state of the vehicle 10. In an example, the detection system 70 includes a wheel speed sensor 71, a front-rear acceleration sensor 72, a transverse acceleration sensor 73, and a yaw rate sensor 74. The wheel speed sensor 71 detects the wheel speed, which is the rotation speed of the wheel 20. The front-rear acceleration sensor 72 detects the front-rear acceleration of the vehicle 10. The transverse acceleration sensor 73 detects the transverse acceleration of the vehicle 10. The yaw rate sensor 74 detects the yaw rate of the vehicle 10. The detection system 70 sends signals corresponding to the detection results to the controller 100.

### Monitoring System

The monitoring system 80 monitors the situation outside the vehicle 10. For example, the monitoring system 80 includes an image capturing device 81, a radar 82, and a GPS receiver 83. The image capturing device 81 captures images outside the vehicle 10. The image capturing device 81 detects other vehicles and obstacles in the traveling direction of the vehicle 10. The radar 82 detects the distance from the vehicle 10 to another vehicle, the distance from the vehicle 10 to an obstacle, and the distance from the vehicle 10 to a pedestrian. The GPS receiver 83 obtains the present position of the vehicle 10. The monitoring system 80 sends information corresponding to the monitoring results to the controller 100.

### Navigation Device

The navigation device 90 stores map data. The map data includes information on road networks, information on the configuration and speed limit of each road forming a road network, and information on refuge areas EPB that are adjacent to the roads. A refuge area EPB is where the vehicle 10 can be stopped safely. A refuge area EPB is, for example, a stop zone, an emergency parking zone, a refuge zone, a parking space, or the like. The navigation device 90 may be an on-board navigation device or an application that runs on a portable terminal such as a smartphone. The navigation device 90 sends information based on the map data to the controller 100.

### Vehicle Control Configuration

The controller 100 includes a CPU and a memory. The memory stores programs executed by the CPU. The CPU corresponds to “the computer” that executes the programs. The CPU executes the programs so that the controller 100 implements the functionalities of functional units. The functional units of the controller 100 include a road determination unit 101, a road configuration acquisition unit 102, an availability computation unit 103, a route generation unit 104, and an instruction unit 105. In the present embodiment, the road configuration acquisition unit 102, the availability computation unit 103, and the route generation unit 104 form “the travel route generation device.”

### Road Determination Unit

The road determination unit 101 uses the map data provided from the navigation device 90 to determine a planned route on which the vehicle 10 will travel from a point of origin to a destination. In the present embodiment, the vehicle 10 is autonomously driven in accordance with the planned route determined by the road determination unit 101.

### Road Configuration Acquisition Unit

The road configuration acquisition unit 102 uses the map data provided from the navigation device 90 to acquire the configuration of the roads in the planned route determined by the road determination unit 101. Preferably, the road configuration includes information on at least the road width and the road curvature. The road configuration acquisition unit 102 acquires the configuration of the road ahead of the vehicle 10 based on the present position of the vehicle 10 that is being autonomously driven. In this case, the road configuration acquisition unit 102 acquires the road configuration of at least the area that can be monitored by the monitoring system 80.

### Availability Computation Unit

The availability computation unit 103 computes the availability of the vehicle 10 that indicates a range reachable by the vehicle 10 during a unit time by actuation of the brake actuator 41, the motor generator 51, and the steering actuator 61.

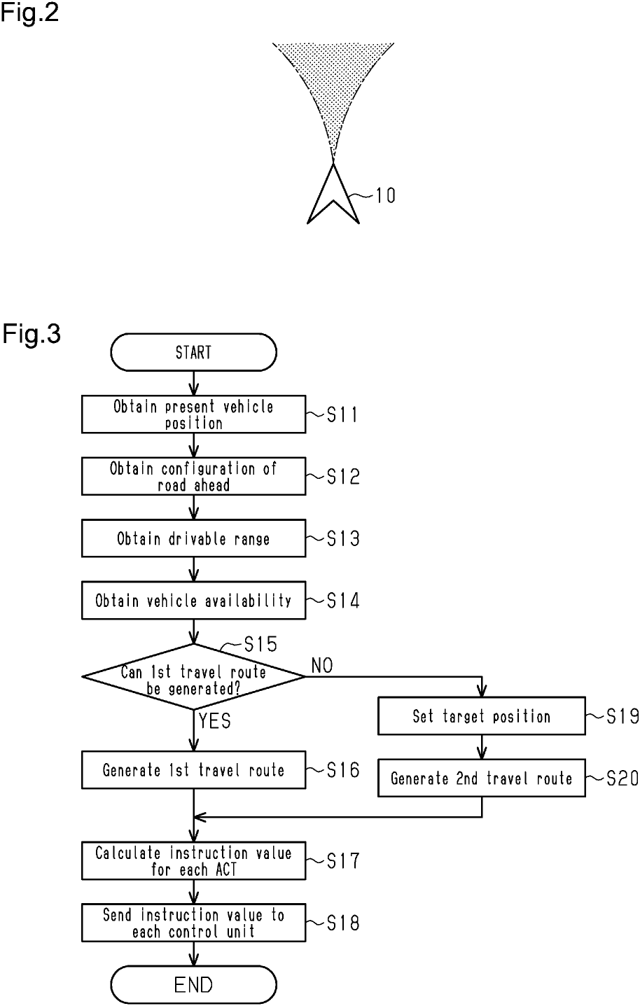

FIG. 2 shows the availability range of the traveling vehicle 10. As shown in FIG. 2, the availability range of the vehicle 10 increases in dimension in the transverse direction of the vehicle 10 toward the traveling direction of the vehicle 10. The availability range of the vehicle 10 changes in accordance with the capabilities of the brake actuator 41, the motor generator 51, and the steering actuator 61. For example, as the capabilities of the brake actuator 41 and the steering actuator 61 become higher, the availability range of the vehicle 10 becomes larger in the transverse direction of the vehicle 10. Further, as the capability of the motor generator 51 becomes higher, the availability range of the vehicle 10 becomes larger in the forward direction of the vehicle 10.

The availability range of the vehicle 10 also changes in accordance with the state quantity of the vehicle 10 such as the speed, front-rear acceleration, transverse acceleration, and yaw rate of the vehicle 10. For example, as the speed of the vehicle 10 becomes lower, the availability range of the vehicle 10 becomes larger in the transverse direction of the vehicle 10. Further, under a situation in which the vehicle 10 is accelerating transversely or yawing, the range extending toward the right in the forward direction of the vehicle 10 will be asymmetric to the range extending toward the left in the forward direction of the vehicle 10. In this manner, the availability computation unit 103 computes the availability of the vehicle 10 from the present capabilities of the brake actuator 41, the motor generator 51, and the steering actuator 61 and the present state quantity of the vehicle 10.

### Route Generation Unit

The route generation unit 104 generates a travel route for the vehicle 10 in predetermined control cycles when the vehicle 10 is autonomously driven. More specifically, the route generation unit 104 generates either a first travel route Tr1, which is a travel route for driving the vehicle 10 along the planned route, or a second travel route Tr2, which is a travel route for safely stopping the vehicle 10. The route generation unit 104 generates a travel route that satisfies the conditions listed below.

A first condition is a condition for generating a travel route along the road ahead of the vehicle 10 from the present position of the vehicle 10. That is, the first condition is for generating the travel route that remains in the same lane in the road ahead of the vehicle 10. In the first condition, the road ahead of the vehicle 10 refers to the road on which the vehicle 10 is about to travel in accordance with the planned route. The route generation unit 104 refers to the road configuration obtained by the road configuration acquisition unit 102 to determine whether the first condition is satisfied.

A second condition is a condition for generating a travel route along which the vehicle 10 can be autonomously driven. The route generation unit 104 refers to the availability of the vehicle 10 computed by the availability computation unit 103 to determine whether the second condition is satisfied. That is, the route generation unit 104 determines whether the travel route can be generated within the availability range of the vehicle 10.

A third condition is a condition for generating a travel route that is free from objects that may interfere with the traveling of the vehicle 10 such as other vehicles and obstacles. The route generation unit 104 refers to the information from the monitoring system 80 to obtain the drivable range in which the vehicle 10 can travel without coming into contact with an object that will interfere with the traveling of the vehicle 10. Then, the route generation unit 104 uses the drivable range to determine whether the third condition is satisfied. That is, the route generation unit 104 determines whether the travel route can be generated within a drivable range.

The route generation unit 104 generate a first travel route Tr1 that satisfies every one of the first condition, the second condition, and the third condition. Thus, the route generation unit 104 generates the first travel route Tr1, along which the vehicle 10 will travel from the present position in the road ahead of the vehicle 10, within the availability range of the vehicle 10. The first travel route Tr1 satisfies the first condition and is thus in accordance with the planned route.

When the vehicle 10 is autonomously driven in accordance with the first travel route Tr1, the availability of the vehicle 10 may change greatly. Further, an object that interferes with the traveling vehicle 10 may appear in the road ahead of the vehicle 10. As a result, the route generation unit 104 will not be able to generate a first travel route Tr1 that satisfies the three conditions. In other words, the controller 100 may not be able to autonomously drive the vehicle 10 safely to the destination.

Under such a situation, when a first travel route Tr1 that satisfies the three conditions cannot be generated, the route generation unit 104 sets a target position Pt to a position ahead of the present position. When there is a refuge area EPB ahead of the present position of the vehicle 10, the route generation unit 104 sets the target position Pt to a position in the refuge area EPB. When there is no refuge area EPB ahead of the present position of the vehicle 10, the route generation unit 104 sets the target position Pt to a position in the road in which the vehicle 10 is traveling. If the vehicle 10 is about to approach a curve when being autonomously driven, the route generation unit 104 sets the target position Pt to a position located before the curve. A road is determined as being a curve based on whether the curvature of the road is greater than or equal to a predetermined determination value. Specifically, when the road curvature is greater than or equal to the determination value, it is determined that the road is a curve. When the road curvature is less than the determination value, it is determined that the road is not a curve.

Then, the route generation unit 104 generates a second travel route Tr2 that satisfies the second condition and the third condition to stop the vehicle 10 at the target position Pt. Thus, the route generation unit 104 generates a travel route that avoids other objects, such as other vehicles and obstacles, so that the vehicle 10 heads toward the target position Pt within the availability range of the vehicle 10. The second travel route Tr2 does not satisfy the first condition and may be a travel route that differs from the planned route.

Preferably, if the first travel route Tr1 cannot be generated when the vehicle 10 is traveling along a curve, the route generation unit 104 sets the target position Pt to a position that is as close as possible to the present position. The route generation unit 104 can set the target position Pt to a position in the curve. If there is a refuge area EPB adjacent to the curve, the route generation unit 104 can set the target position Pt to a position in the refuge area EPB.

### Instruction Unit

The instruction unit 105 calculates instruction values used to drive the brake actuator 41, the motor generator 51, and the steering actuator 61 based on the travel route generated by the route generation unit 104. Then, the instruction unit 105 sends the instruction values to the brake control unit 42, the drive control unit 52, and the steering control unit 62. This allows the vehicle 10 to be autonomously driven along the first travel route Tr1 or the second travel route Tr2.

With reference to FIG. 3, the flow of a process executed by the CPU of the controller 100 will now be described. The process is executed in predetermined control cycles after a planned route is determined. In other words, the process is repeatedly executed when the vehicle 10 is being autonomously driven.

As shown in FIG. 3, the CPU refers to a signal from the GPS receiver 83 to obtain the present position of the vehicle 10 (S11). Then, the CPU refers to information from the navigation device 90 to obtain the configuration of the road ahead of the present position of the vehicle 10 (S12). Further, the CPU refers to the information from the monitoring system 80 to obtain the drivable range of the vehicle 10 (S13). Subsequently, the CPU computes the availability of the vehicle 10 from the present capability of each actuator and the present state quantity of the vehicle 10 (S14).

Based on the information obtained or computed in steps S12 to S14, the CPU determines whether a first travel route Tr1 that satisfies the first condition, the second condition, and the third condition can be generated (S15). When the CPU determines that a first travel route Tr1 that satisfies the three conditions can be generated (S15: YES), that is, when the vehicle 10 can continue to be autonomously driven toward the destination, the CPU generates a first travel route Tr1 that satisfies the three conditions (S16). Based on the generated travel route, the CPU then calculates instruction values for the brake actuator 41, the motor generator 51, and the steering actuator 61 (S17). Further, the CPU sends the instruction values to the brake control unit 42, the drive control unit 52, and the steering control unit 62 (S18). This allows the CPU to adjust the braking force applied to the vehicle 10, the driving force applied to the vehicle 10, and the steering angle of the wheels 20. In other words, traveling control is executed on the vehicle 10 based on the travel route.

When a first travel route Tr1 that satisfies the three conditions cannot be generated in step S15 (S15: NO), that is, when the vehicle 10 cannot continue autonomous driving to the destination, the CPU sets a target position Pt for a second travel route Tr2 (S19).

In step S19, the CPU determines whether there is a curve ahead of the vehicle 10. If there is a curve ahead of the vehicle 10 when the vehicle 10 is traveling along a straight road, the CPU sets the target position Pt to a position located before the curve. If there is no curve ahead of the vehicle 10 when the vehicle 10 is traveling along a straight road, the CPU sets the target position Pt to a position ahead of the vehicle 10. If there is no curve ahead of the vehicle 10 when the vehicle 10 is traveling along a curve, the CPU sets the target position Pt to a position in the curve where the vehicle 10 is traveling.

Further, the CPU determines whether there is a refuge area EPB ahead of the vehicle 10. When there is a refuge area EPB ahead of the vehicle 10, the CPU sets a target position Pt to a position in the refuge area EPB. When there is no refuge area EPB ahead of the vehicle 10, the CPU sets the target position Pt to a position in the road where the vehicle 10 is traveling.

Then, the CPU generates a second travel route Tr2 that satisfies the second condition and the third condition to stop the vehicle 10 at the target position Pt (S20). Afterward, the CPU proceeds to step S18.

Depending on the target position Pt set in step S19, the second travel route Tr2 may not satisfy the second condition and the third condition. For example, in step S20, when the distance from the present position of the vehicle 10 to where a curve starts is less than the distance needed for braking, the CPU may not be able to generate the second travel route Tr2 with the target position Pt set to a position located before the curve within the availability range of the vehicle 10. Further, in step S20, when an anomaly occurs in the steering actuator 61, the CPU may not be able to generate a second travel route Tr2 with the target position Pt set in a refuge area EPB within the availability range of the vehicle 10.

In such a case, the CPU generates a second travel route Tr2 based on a target position Pt that is reset. That is, the CPU repeats steps S19 and S20 until it generates a second travel route Tr2 that satisfies the second condition and the third condition and stops the vehicle 10 at the target position P. In this respect, in step S20, even if the vehicle 10 is approaching a curve, the target position Pt may be set to a position located in the curve depending on the availability of the vehicle 10.

In the process described above, step S14 corresponds to “the availability computation process.” Further, step S16 corresponds to “the first route generation process” and steps S19 and S20 correspond to “the second route generation process.”

Preferably, in the present embodiment, the path for supplying electric power to the brake actuator 41, the motor generator 51, and the steering actuator 61 is provided with redundancy. Preferably, in the same manner, the communication path extending from the controller 100 to the detection system 70, the monitoring system 80, and the navigation device 90 and the communication path extending from the controller 100 to the brake control unit 42, the drive control unit 52, and the steering control unit 62 are provided with redundancy.

### Operation and Advantages of Embodiment

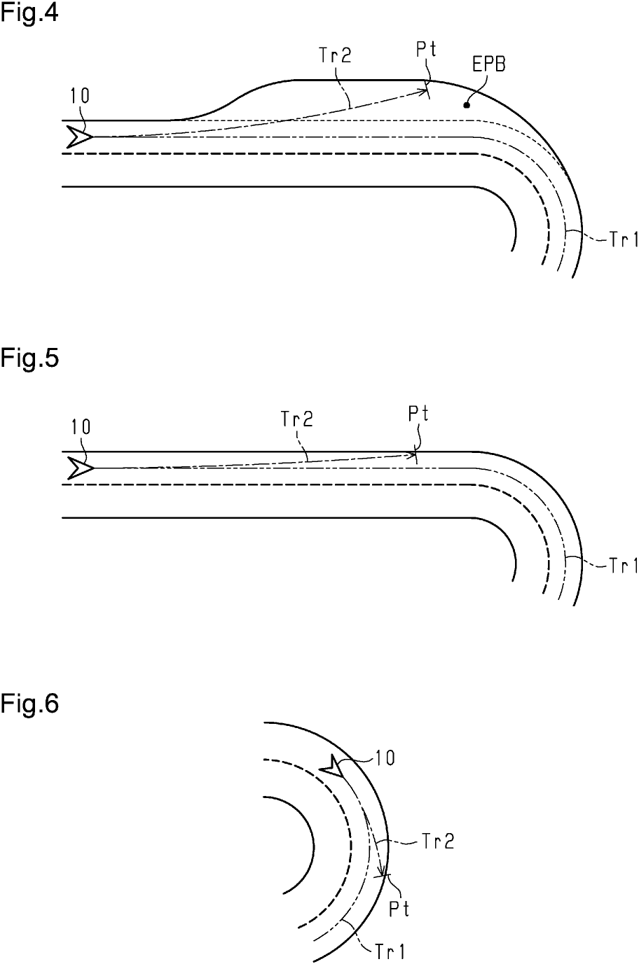

A case in which the vehicle 10 is autonomously driven along the first travel route Tr1 or the second travel route Tr2 will now be described with reference to FIGS. 4 to 6. FIGS. 4 to 6 each show a two-way road with a single lane on each side of the road. Thus, the road includes a driving lane and an oncoming lane. FIGS. 4 and 5 each show a state in which the vehicle 10 is being autonomously driven and approaching a curve, and FIG. 6 shows a state in which the vehicle 10 is being autonomously driven in a curve.

As shown by the double-dashed line in FIGS. 4 to 6, when the first travel route Tr1, which satisfies the three conditions, is satisfied, the vehicle 10 is autonomously driven along the first travel route Tr1. That is, the vehicle 10 can be driven along a road that includes a curve.

When an anomaly occurs in the steering actuator 61, the capability of the steering actuator 61 may be adversely affected. This may narrow the steering angle adjustment range of the wheels 20 and reduce the availability range of the vehicle 10 in size. In such a case, a first travel route Tr1 that satisfies the three conditions cannot be generated. Therefore, as shown by the single-dashed line in FIGS. 4 to 6, the second travel route Tr2 is generated instead of the first travel route Tr1. Then, the vehicle 10 is autonomously driven along the second travel route Tr2 and stopped at the target position Pt.

As shown in FIG. 4, when there is a refuge area EPB adjacent to the road between the present position of the vehicle 10 and the curve, the second travel route Tr2 is generated with the target position Pt set to a position in the refuge area EPB. In this manner, the vehicle 10 is stopped in the refuge areas EPB just before the curve. As a result, the stopped vehicle 10 will not interfere with a rear vehicle that is traveling.

As shown in FIG. 5, when there is no refuge area EPB adjacent to the road between the present position of the vehicle 10 and the curve, the second travel route Tr2 is generated with the target position Pt set to a position in the road located before the curve. Preferably, in this case, the target position Pt is set to a position near the shoulder of the road. In this manner, the vehicle 10 is stopped on the road just before the curve. As a result, the stopped vehicle 10 will not interfere with a rear vehicle that is traveling. The phrase “when there is no refuge area EPB” includes a case where there actually is no refuge area EPB and a case where there actually is a refuge area EPB but it cannot be found from information of the monitoring system 80.

As shown in FIG. 6, if a first travel route Tr1 cannot be generated when the vehicle 10 is traveling along a curve, a second travel route Tr2 is generated with the target position Pt set to a position close to the present position of the vehicle 10. Preferably, in this case, the target position Pt is set to a position near the shoulder of the road. As a result, the vehicle 10 will be readily stopped. If a first travel route Tr1 cannot be generated when the vehicle 10 is traveling along a curve and a second travel route Tr2, which sets the target position Pt to a position located before the curve, then a second travel route Tr2 such as that shown in FIG. 6 may be generated.

In the case described above, a first travel route Tr1, which satisfies the three conditions, cannot be generated due to an anomaly in the steering actuator 61 that reduces the availability range in size. The same process is performed when a first travel route Tr1 satisfying the three conditions cannot be generated.

When the vehicle 10 can be autonomously driven safely to the destination, the controller 100 generates only a first travel route Tr1 that is in accordance with the planned route. When the vehicle 10 can no longer be autonomously driven safely to the destination, the controller 100 generates the second travel route Tr2 instead of the first travel route Tr1 to safely stop the vehicle 10. Accordingly, when the vehicle 10 cannot continue autonomous driving, the controller 100 stops the vehicle 10 at the safest position. Further, the controller 100 generates the second travel route Tr2 only when the first travel route Tr1 cannot be generated. This reduces the control load as compared with when the first travel route Tr1 and the second travel route Tr2 are both always generated.

### Modified Examples

The above embodiment may be modified as described below. The above embodiment and the following modifications can be combined as long as there is no technical contradiction.

The availability range of the vehicle 10 tends to be smaller when the friction coefficient between the wheels 20 and the road surface is small than when the friction coefficient between the wheels 20 and the road surface is large. Thus, the availability computation unit 103 can use the friction coefficient between the wheels 20 and the road surface to compute the availability of the vehicle 10. For example, the controller 100 may use an image of the road surface captured by the image capturing device 81 to estimate the friction coefficient between the wheels 20 and the road surface.

The route generation unit 104 does not have to obtain information on the refuge areas EPB. In this case, when the route generation unit 104 cannot generate a first travel route Tr1 that satisfies the three conditions, the route generation unit 104 generates a second travel route Tr2 with the target position Pt set to a position in the road ahead of the vehicle 10.

When the route generation unit 104 cannot generate a first travel route Tr1 that satisfies the three conditions, the route generation unit 104 can set the target position Pt on the border between a refuge area EPB and the road. In this case, the vehicle 10 is stopped over the refuge area EPB and the road. For example, when an anomaly in the steering actuator 61 reduces the availability range of the vehicle 10 in size, the target position Pt may be set to a position on the border of a refuge area EPB and the road.

Under a situation in which the vehicle 10 is traveling along a curve, when a first travel route Tr1 satisfying the three conditions cannot be generated, the controller 100 can generate a second travel route Tr2 without setting the target position Pt to readily start braking of the vehicle 10. In other words, the controller 100 can generate a second travel route Tr2 that gives priority to braking.

Ayaw moment acts on the vehicle 10 when, for example, the driving force applied to the right wheel differs from that applied to the left wheel or when the braking force applied to the right wheel differs from that applied to the left wheel. Accordingly, the controller 100 may compensate for the reduction within the availability range of the vehicle 10 as the capability of the steering actuator 61 falls by actuating the brake actuator 41 and the motor generator 51.

The controller 100 does not have to include a CPU and ROM and process software. That is, the device (controller 100 or travel route generation device) may include processing circuitry having any one of following configurations (a) to (c).

(a) Processing circuitry including one or more processors executing processes in accordance with computer programs. Each processor includes a CPU and a memory such as a RAM and ROM. The memory stores program codes or instructions configured to have the CPU execute processes. The memory, namely, a computer-readable medium, includes any available medium that is accessible by a versatile or dedicated computer.

(b) Processing circuitry including one or more dedicated hardware circuits that execute various processes. The dedicated hardware circuits may include, for example, an Application Specific Integrated Circuit (ASIC) or a Field Programmable Gate Array (FPGA).

(c) Processing circuitry including a processor that executes parts of processes in accordance with computer programs and a dedicated hardware circuit that executes the remaining parts of the processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A travel route generation device that generates a travel route followed by a vehicle when the vehicle is autonomously driven by actuation of an actuator related to traveling of the vehicle, the travel route generation device comprising:
an availability computation unit configured to compute availability of the vehicle that indicates a range reachable by the vehicle by actuation of the actuator; and
a route generation unit configured to generate a first travel route within a range of the availability of the vehicle, as the travel route followed by the vehicle, when the vehicle travels along a road ahead of the vehicle from a present position;
wherein when the road includes a curve and the first travel route cannot be generated within the availability range, the route generation unit is configured to set a target position to a position located before the curve and generate a second travel route within the availability range, as the travel route followed by the vehicle, to stop the vehicle at the target position.

2. The travel route generation device according to claim 1, wherein:
a refuge area is an area adjacent to the road where the vehicle can be stopped; and
wherein under a situation in which the road includes a curve and the first travel route cannot be generated within the availability range, when the refuge area is located between the present position and the curve, the route generation unit is configured to set the target position to a position located in the refuge area.

3. The travel route generation device according to claim 1, wherein when the road includes a curve and the first travel route cannot be generated within the availability range, the route generation unit is configured to set the target position to a position in the road located before the curve.

4. The travel route generation device according to claim 1, wherein when the vehicle is traveling along a curve and the first travel route cannot be generated within the availability range, the route generation unit is configured to generate the second travel route within the availability range to stop the vehicle.

5. A vehicle controller, comprising:
the travel route generation device according to claim 1; and
an instruction unit configured to calculate an instruction value for the actuator based on the travel route generated by the route generation device and send the instruction value to a controller for the actuator in order to autonomously drive the vehicle.

6. A non-transitory computer-readable medium that stores a travel route generation program executed by a computer of a vehicle, the travel route generation program is configured to have the computer generate a travel route followed by the vehicle when the vehicle is autonomously driven by actuation of an actuator related to traveling of the vehicle, the travel route generation program has the computer execute:
an availability computation process that computes availability of the vehicle that indicates a range reachable by the vehicle by actuation of the actuator;
a first route generation process that generates a first travel route within a range of the availability of the vehicle, as the travel route followed by the vehicle, when the vehicle travels along a road ahead of the vehicle from a present position; and
a second route generation process that, when the road includes a curve and the first travel route cannot be generated within the availability range, sets a target position to a position located before the curve and generates a second travel route within the availability range, as the travel route followed by the vehicle, to stop the vehicle at the target position.
